(19) United States
(12) Patent Application Publication
(10) Pub. No.: US 2018/0074247 A1
(43) Pub. Date: Mar. 15, 2018

(54) ILLUMINATION DEVICE

(71) Applicant: Japan Display Inc., Minato-ku (JP)

(72) Inventors: Youichi ASAKAWA, Tokyo (JP); Toshihiko FUKUMA, Tokyo (JP); Ken ONODA, Tokyo (JP); Shinichi KOMURA, Tokyo (JP)

(73) Assignee: Japan Display Inc., Minato-ku (JP)

(21) Appl. No.: 15/699,316

(22) Filed: Sep. 8, 2017

(30) Foreign Application Priority Data
Sep. 12, 2016 (JP) 2016-177691

(51) Int. Cl. F21V 8/00

(52) U.S. Cl. CPC G02B 6/003; G02B 6/0021; G02B 6/0038; G02B 6/0068

(57) ABSTRACT

According to one embodiment, an illumination device includes a light guide, a plurality of light sources, and a plurality of light diffusion structures. The light guide extends in a first direction and a second direction and having a thickness in a third direction. The plurality of light sources includes a first laser element and a second laser element. The plurality of light diffusion structures provides to correspond to the respective light sources, and located on an incidence surface of the light guide or between the incidence surface and the light sources. The light sources are arranged in the second direction. The first laser element and the second laser element are arranged in the first direction or the third direction, in each of the light sources.

### CROSS-REFERENCE TO RELATED APPLICATIONS

This application is based upon and claims the benefit of priority from Japanese Patent Application No. 2016-177691, filed Sep. 12, 2016, the entire contents of which are incorporated herein by reference.

### FIELD

Embodiments described herein relate generally to an illumination device.

### BACKGROUND

A display device such as a liquid crystal display device comprises, for example, a display panel including pixels, and an illumination device for applying light to the display panel. The illumination device comprises a light source which emits light and a light guide which is irradiated with the light from the light source. The light from the light source propagates inside the light guide and is emitted from an emission surface of the light guide. By using a plurality of light sources emitting the light of different colors, emitted light of a desired color made by mixing these colors can also be obtained.

When the light having diffusibility in a shorter side direction and a thickness direction of the light guide is made incident on the light guide, the efficiency of use of the light is lowered since the light is repeatedly reflected inside the light guide and absorbed into the light guide. In contrast, when the light having a parallel property in the shorter side direction and the thickness direction of the light guide is made incident on the light guide, non-uniformity in luminance can easily occur on the emission surface of the light guide while the efficiency of use of the light is excellent. In addition, positioning accuracy of the incidence surface of the light guide and the optical axis needs to be strictly managed, and manufacturing costs are therefore increased.

Moreover, the light having a parallel property in a shorter side direction of the light guide and having diffusibility in a thickness direction of the light guide is considered to be made incident on the light guide. The light is not mixed in the direction of the shorter side of the light guide inside the light guide. When a structure in which light beams of different colors are mixed inside the light guide and a desired color is obtained is adopted, the light beams of the colors may not be mixed uniformly.

If the light colors can hardly be mixed inside the light guide, color-mixed light needs to be preliminarily made incident on the light guide before the light beams are made incident on the light guide. If an optical system for mixing the light of different colors is added outside the light guide, the miniaturization of an illumination device is difficult.

### BRIEF DESCRIPTION OF THE DRAWINGS

FIG. 1 is a partially exploded perspective view showing a schematic structure of a liquid crystal display device as an example of a display device.

FIG. 2 is a perspective diagram showing a schematic structure of the illumination device according to a first embodiment.

FIG. 3 is a right side view of the illumination device shown in FIG. 2.

FIG. 4 is a plan view showing the illumination device shown in FIG. 2.

FIG. 5 is a cross-sectional view seen along line F5-F5 in FIG. 2.

FIG. 6 is a cross-sectional view seen along line F6-F6 in FIG. 2.

FIG. 7 is a cross-sectional view showing another example of an optical diffusion structure.

FIG. 8 is a cross-sectional view seen along line F6-F6 in FIG. 7.

FIG. 9 is a graph showing an intensity distribution of the light transmitted through the optical diffusion structure.

FIG. 10 is a perspective view showing the other example of the collimating lens.

FIG. 11 is a cross-sectional view seen along line F11-F11 in FIG. 10.

FIG. 12 is a plan view showing another example of the first embodiment.

FIG. 13 is a perspective view showing a schematic structure of an illumination device according to a second embodiment.

FIG. 14 is a cross-sectional view seen along line F14-F14 in FIG. 13.

FIG. 15 is a plan view of the illumination device shown in FIG. 13.

FIG. 16 is a perspective view showing a schematic structure of an illumination device according to a third embodiment.

FIG. 17 is a right side view of the illumination device shown in FIG. 16.

FIG. 18 is a front view of the illumination device shown in FIG. 16.

### DETAILED DESCRIPTION

In general, according to one embodiment, an illumination device includes a light guide, a plurality of light sources, a plurality of light diffusion structures. The light guide extends in a first direction and a second direction intersecting the first direction and having a thickness in a third direction intersecting the first and second directions. The plurality of light sources includes a first laser element emitting light of a first color and a second laser element emitting light of a second color different from the first color, and applying light to the light guide. The plurality of light diffusion structures provides to correspond to the respective light sources, and located on an incidence surface of the light guide on which light from the light sources is made incident or between the incidence surface and the light sources. The light sources are arranged in the second direction. The first laser element and the second laser element are arranged in the first direction or the third direction, in each of the light sources.

Embodiments will be described hereinafter with reference to the accompanying drawings. Incidentally, the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, and the like of the respective parts are schematically illustrated in the drawings, compared to the actual modes. However, the schematic illustration is merely an example, and adds no restrictions to the interpretation of the invention. Besides, in the specification and drawings, the structural elements having functions, which are identical or similar to the functions of the structural elements described in connection with preceding drawings, are denoted by like reference numerals, and an overlapping detailed description is omitted unless otherwise necessary.

In each of the embodiments, a liquid crystal display device DSP is described as an example of a display device. The liquid crystal display device DSP can be used for various devices, for example, a smartphone, a tablet terminal, a mobile telephone terminal, a personal computer, a TV receiver, a vehicle-mounted device, a game console and a wearable terminal and the like.

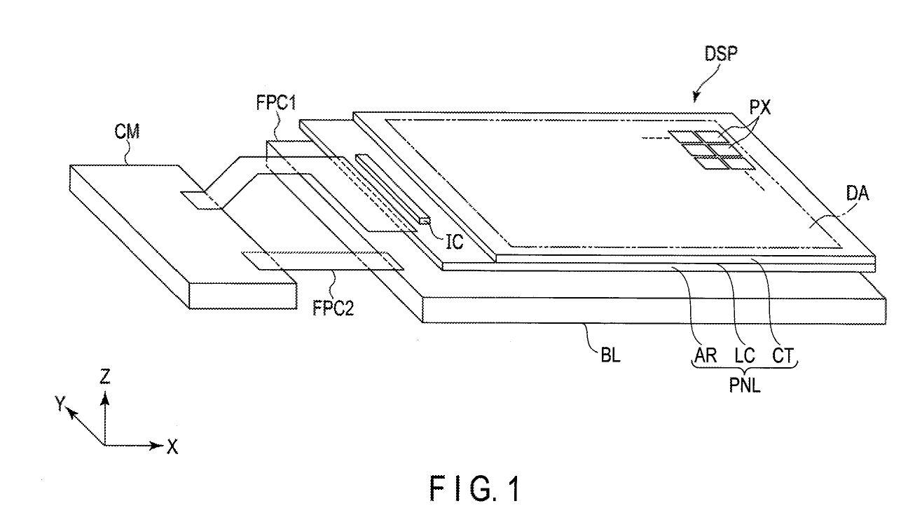

First, a structure common to the embodiments will be explained with reference to FIG. 1. FIG. 1 is a partially exploded perspective view showing a schematic structure of the liquid crystal display device DSP.

The liquid crystal display device DSP comprises a display panel PNL, an illumination device (backlight) BL which applies light to the display panel PNL, a control module CM which controls operations of the display panel PNL and the illumination device BL, a driver IC chip IC which drives the display panel PNL, and flexible printed circuits FPC1 and FPC2 which transmit control signals of the control module CM to the display panel PNL and the illumination device BL.

In each of the embodiments, a first direction X, a second direction Y, and a third direction Z are defined as shown in FIG. 1. The first direction X and the second direction Y correspond to the directions of a longer side 10X and a shorter side 10Y of a light guide 10 to be explained later, respectively. The third direction Z corresponds to a thickness direction of the light guide 10. The first direction X is also a direction of, for example, a long side of the display panel PNL. The second direction Y is also a direction of, for example, a shorter side of the display panel PNL. The third direction Z is a direction intersecting the first direction X and the second direction Y. In the example illustrated in FIG. 1, the first to third directions X, Y, and Z are perpendicular to each other. The first to third directions X, Y, and Z may cross at the other angles.

The display panel (liquid crystal cell) PNL comprises an array substrate AR, a counter-substrate CT opposed to the array substrate AR, and a liquid crystal layer LC disposed between the array substrate AR and the counter-substrate CT. The liquid crystal layer LC is an example of an optical element which allows light to be selectively transmitted. The display panel PNL includes a display area DA in which an image is displayed. The display panel PNL includes a plurality of pixels PX arrayed in a matrix in the first direction X and the second direction Y, in the display area DA.

The control module CM successively receives image data for one frame for the display in the display area DA from a main board or the like of an electronic device in which the liquid crystal display device LCD is built. The image data includes, for example, information such as a display color of each pixel PX. The control module CM supplies a signal to drive each pixel PX, based on the received image data, to the display panel PNL. In addition, the control module CM supplies a signal to drive a plurality of light sources LS to be explained later separately, based on the received image data, to the illumination device BL. The control module CM is an example of a controller.

The driver IC chip IC is mounted on, for example, the array substrate AR. The driver IC chip IC may be mounted on the control module CM or the like. The flexible printed circuit FPC1 makes connection between the array substrate AR and the control module CM. The flexible printed circuit FPC2 makes connection between the illumination device BL and the control module CM.

The illumination device BL is disposed to be opposed to the array substrate AR of the display panel PNL to apply light to the display panel PNL from the back side.

### First Embodiment

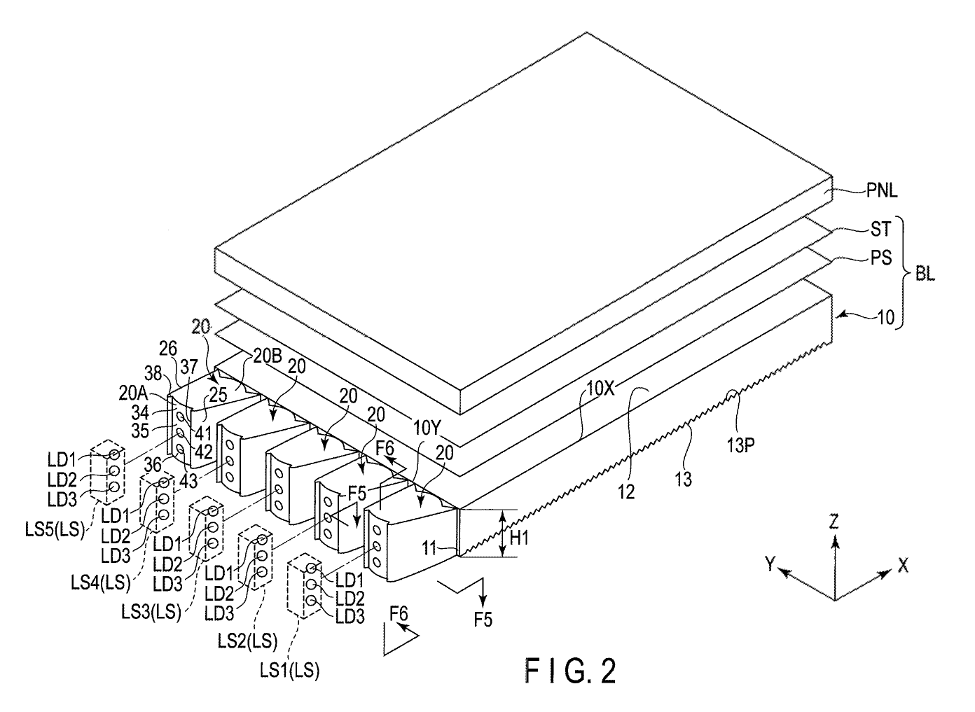

FIG. 2 is a perspective view showing a schematic structure of the illumination device BL of the first embodiment. The illumination device BL comprises, for example, a light guide 10, a plurality of light sources LS (LS1, LS2, LS3, LS4, and LS5), a plurality of collimating lenses 20 provided to correspond to the respective light sources LS, a prism sheet PS, and a diffusion film ST.

The light guide 10 is, for example, a plate-shaped member formed of a resin material having a light transmission property. The light guide 10 is disposed on the back side of the display panel PNL and opposed to the array substrate AR. The long side 10X of the light guide 10 extends in the first direction X. The shorter side 10Y of the light guide 10 extends in the second direction Y. The thickness direction of the light guide 10 matches the third direction Z. The thickness of the light guide 10 does not need to be uniform and may be different at least partially. For example, the light guide 10 may be formed in a wedge shape which increases in thickness at a position more distant from the light source LS.

A prism sheet PS is disposed between the light guide 10 and the display panel PNL to direct the light path of the light emitted from the light guide 10 to the display panel PNL. The prism sheet PS is, for example, a resin film excellent in light transmitting property, and includes a prism surface on which a prism pattern is formed and a flat surface on which a prism pattern is not formed. For example, the prism surface is opposed to the light guide 10 while the flat surface is opposed to the display panel PNL. The prism surface may be opposed to the display panel and the flat surface may be opposed to the light guide 10.

The diffusion film ST is disposed between the prism sheet PS and the display panel PNL. The diffusion film ST is, for example, a resin film in which scattering particles are dispersed. A fine lens structure may be formed on the surface of the film instead of dispersion of the scattering particles. The scattering particles are not particularly limited if the particles scatter the light, and the particles may be organic particles or inorganic particles.

The organic particles are, for example, resin particles such as an acrylate resin, a silicon resin, and a styrene resin. The inorganic particles are, for example, ceramic particles of silica, alumina and the like, and metal particles of aluminum, copper, iron and the like. According to the diffusion film ST, the non-uniformity in luminance in the images of the liquid crystal display device DSP can be reduced and the viewing angle characteristics can be improved. The diffusion film ST is not an indispensable constituent element but can be omitted.

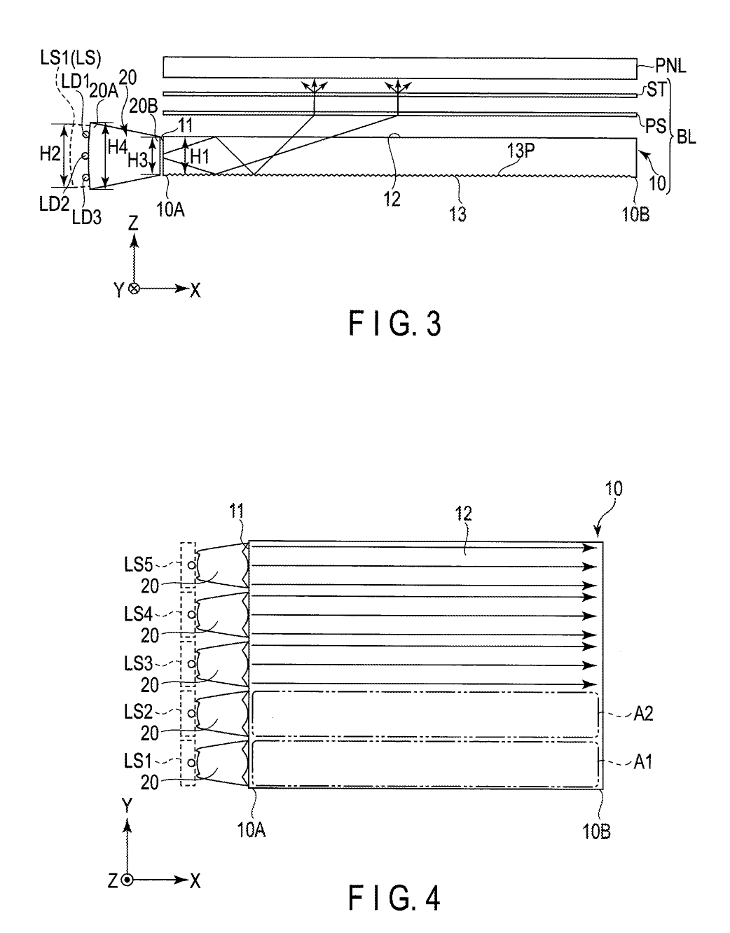

FIG. 3 is a right side view of the illumination device BL seen from the second direction Y. FIG. 4 is a plan view of the illumination device BL seen from the third direction Z. As shown in FIG. 3, the light guide 10 has a side surface 11, a first main surface 12, and a second main surface 13. The side surface 11 is opposed to the light source LS. The first main surface 12 is opposed to the display panel PNL.

In the present embodiment, the light applied from each light source LS is made incident on the side surface 11. A prism pattern 13P which reflects the light incident on the side surface 11 toward the first main surface 12 is formed on the second main surface 13. A prism pattern which leads the light to the display panel PNL may be formed on the first main surface 12 instead of the prism pattern 13P. The side surface 11 and the first main surface 12 may be called an incidence surface and an emission surface, respectively.

As shown in FIG. 2, each light source LS includes a first laser element LD1 which emits the light of a first color, a second laser element LD2 which emit the light of a second color, and a third laser element LD3 which emit the light of a third color. For example, the first color is red (R), the second color is green (G), and the third color is blue (B). The first to third colors are not limited to three primary colors but may be the other colors.

Each of the laser elements LD (first to third laser elements LD1, LS2, and LD3) is a semiconductor laser which emits laser light, or the like, or a point source which applies diverging light having divergence about the first direction X. More specifically, if a relative intensity of the light emitted from the laser element LD seen from the first direction X (optical axis having the highest radiation intensity) is set at 1.0, the range of the viewing angle of the light (half width, i.e., full width at half maximum (FWHM)) where the relative intensity is larger than or equal to a half (0.5) of the maximum value in second direction Y is, for example, approximately 30 degrees (−15 degrees to 15 degrees). In contrast, the range of the viewing angle in which the relative intensity is larger than or equal to a half in the third direction Z is, for example, approximately 10 degrees (−5 to 5 degrees). In other words, the divergence of the light from each laser element is narrower in the third direction Z than in the second direction Y. The first to third laser elements LD1, LD2, and LD3 are mounted on, for example, a wiring board electrically connected with the above-explained flexible printed circuit FPC2.

As shown in FIG. 2, the light sources LS (LS1, LS2, LS3, LS4, and LS5) are arranged along the shorter side 10Y of the light guide 10 and apply the light to the side surface (incidence surface) 11 of the light guide 10. In the example illustrated in FIG. 2, five light sources LS are arranged. The number of the light sources LS may be four or less or six or more. The number of the light sources LS can be suitably adjusted in accordance with the size of the light guide 10.

In each of the light sources LS, the first to third laser elements LD1, LD2, and LD3 are arranged along the third direction Z (the thickness direction of the light guide 10). In other words, the first to third laser elements LD1, LD2, and LD3 are arranged along the third direction Z, in the light source LS1. Similarly, the first to third laser elements LD1, LD2, and LD3 are arranged in the third direction Z, in each of the light sources LS2, LS3, LS4, and LS5. In such a position, each of the laser elements LD is fixed in a direction in which the half width is large in the direction (second direction Y) of arrangement of the light sources LS and the half width becomes narrow in the direction (third direction Z) of arrangement of the laser elements LD.

As shown in FIG. 2, the collimating lens 20 is provided to correspond to each of the light sources LS1, LS2, LS3, LS4, and LS5, and is disposed between the light source LS and the side surface 11 of the light guide 10. A proximal end 20A of the collimating lens 20 is opposed to the light source LS, and a distal end 20B of the collimating lens 20 is opposed to the side surface 11.

The collimating lens 20 is an example of the lens (hereinafter called an optical director) converting the light emitted from the light source LS into light having a parallel property in the second direction Y and having a diffusibility in the third direction Z. The proximal end 20A is an example of the incidence side of the collimating lens 20, and the distal end 20B is an example of the emission side of the collimating lens 20. The collimating lens 20 converts the light applied from the light source LS into the light having the parallel property in second direction Y and the diffusibility in the third direction Z by controlling the width of the light in the second direction Y.

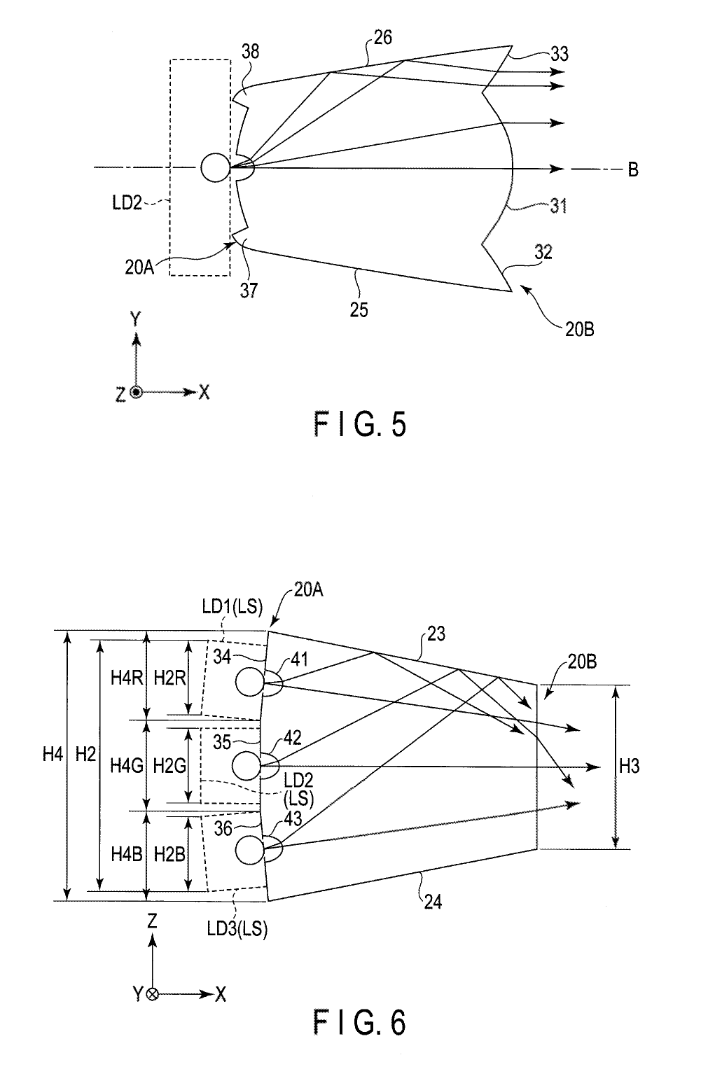

FIG. 5 is a cross-sectional view of the collimating lens 20 seen along line F5-F5 in FIG. 2. FIG. 6 is a cross-sectional view of the collimating lens 20 seen along line F6-F6 in FIG. 2. As shown in FIG. 5 and FIG. 6, the collimating lens 20 has the proximal end 20A and the distal end 20B on which the lens surfaces are formed, and side surfaces (upper surface, lower surface, left side, and right side) 23, 24, 25, and 26 that connect the proximal end 20A and the distal end 20B. In the example shown in FIG. 5 and FIG. 6, each of the side surfaces 23, 24, 25, and 26 is formed in a planar shape.

In addition, in the example shown in FIG. 5 and FIG. 6, the collimating lens 20 is formed to be larger in the second direction Y and smaller in the third direction Z, toward the first direction X. In other words, the distal end 20B is larger than the proximal end 20A in the second direction Y, and the distal end 20B is smaller than the proximal end 20A in the third direction Z. A thickness H3 of the distal end 20B shown in FIG. 3 and FIG. 6 in the third direction Z is formed to be approximately equal to, for example, a thickness H1 of the side surface 11 of the light guide 10 in the third direction Z. A thickness H4 of the proximal end 20A in the third direction Z is formed to be approximately equal to, for example, a thickness H2 of the light source LS in the third direction Z.

In addition, in the example shown in FIG. 5 and FIG. 6, the collimating lens 20 is formed to be bilaterally symmetrical in the second direction Y and vertically symmetrical in the third direction Z. A line which bisects the collimating lens 20 in the second direction Y shown in FIG. 5 is represented as a bisector B.

As shown in FIG. 5, the distal end 20B of the collimating lens 20 has a first lens surface 31, and a second lens surface 32 and a third lens surface 33 provided on the right and left ends of the first lens surface 31. The first to third lens surfaces 31, 32, and 33 have a shape (cylindrical surface) obtained by partially cutting a column having a central axis along the third direction Z. A central axis of the first lens surface 31 is arranged at the position which intersects the bisector B of the collimating lens 20. The second lens surface 32 makes an acute angle with the side surface 25, and is arranged at the position where the central axis does not intersect the bisector B. Similarly, the third lens surface 33 makes an acute angle with the side surface 26, and is arranged at the position where the central axis does not intersect the bisector B.

As shown in FIG. 6, the proximal end 20A of the collimating lens 20 has a fourth surface 34, a fifth surface 35, and a sixth surface 36 arranged in the vertical direction. Thicknesses H4R, H4G, and H4B of the fourth to sixth surfaces 34, 35, and 36 in the third direction Z are formed to be approximately equal to the thicknesses of the first to third laser elements LD1, LD2, and LD3 in the third direction Z, respectively.

As shown in FIG. 5 and FIG. 2, edge portions 37 and 38 protruding from the fourth to sixth surfaces 34, 35, and 36 are provided on the right and left sides of the fourth to sixth surfaces 34, 35, and 36. The second lens surface 32 and the edge portion 37 are connected to each other by the above-explained side surface 25. The third lens surface 33 and the edge portion 38 are connected to each other by the above-explained side surface 26.

As shown in FIG. 6, first to third recess portions 41, 42, and 43 are formed on the fourth to sixth surfaces 34, 35, and 36 so as to correspond to the first to third laser elements LD1, LD2, and LD3, respectively. The first to third recess portions 41, 42, and 43 are examples of the optical diffusion structure. The first to third recess portions 41, 42, and 43 are formed on, for example, parabola-like concave surfaces, respectively. The first to third recess portions 41, 42, and 43 may be formed on, for example, the concave surfaces narrower in the third direction Z than in the second direction Y, in accordance with the shape of the light from the first to third laser elements LD1, LD2, and LD3.

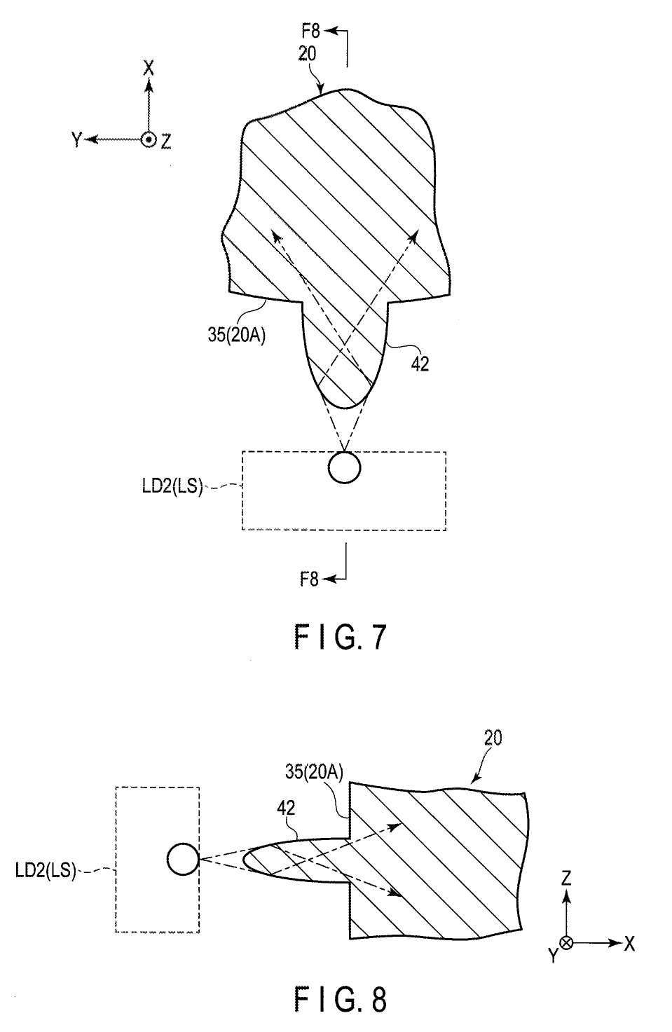

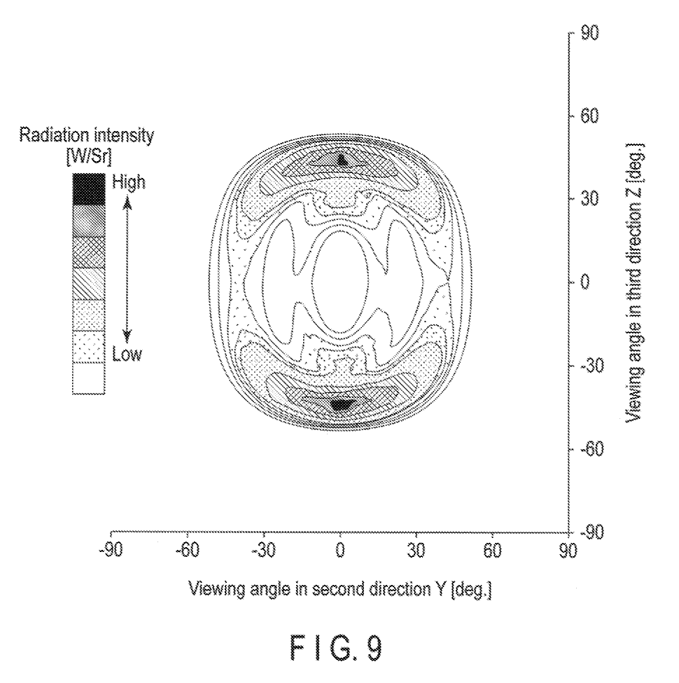

FIG. 7 is a cross-sectional view showing another example of the optical diffusion structure. FIG. 8 is a cross-sectional view seen along line F8-F8 line in FIG. 7. Since the optical diffusion structure aims to extend the optical path, the surface shape is not limited to the concave shape but may be a convex shape as shown in FIG. 7 and FIG. 8. FIG. 9 is a graph showing the intensity distribution of the light transmitted through the optical diffusion structure (second recess portion 42). The optical diffusion structure (recess or convex) corresponding to the laser elements LD arranged in the third direction Z is desirably formed such that the radiation intensity of the light transmitted through the optical diffusion structure becomes higher in the thickness direction (third direction Z) of the light guide 10 as shown in FIG. 9.

The fourth surface 34 is slightly inclined to the fifth surface 35 and the light from the first laser element LD1 is emitted slightly downwardly (inwardly). The sixth surface 36 is slightly inclined to the fifth surface 35 and the light from the third laser element LD3 is emitted slightly upwardly (inwardly).

As shown in FIG. 5 and FIG. 6, the light emitted from the first to third laser element LD1, LD2, and LD3 are made incident on the first to third recesses portions 41, 42, and 43, such that the light is widened in the second direction Y and the third direction Z. The light passed through the first to third recess portions 41, 42, and 43 is passed through the first to third lens surfaces 21, 22, and 23, directly or after reflected on the side surfaces 23, 24, 25, and 26.

The first to third lens surfaces 21, 22, and 23 control the width of the light in the second direction Y. For this reason, the light passed through the collimating lens 20 keeps the diffusibility in the third direction Z as shown in FIG. 6 and FIG. 3, while the light is converted into the light having the parallel property in the second direction Y as shown in FIG. 5 and FIG. 4.

As shown in FIG. 3, the light incident on the side surface 11 of the light guide 10 through collimating lens 20 has the diffusibility in the third direction Z. For this reason, the light is reflected on the first main surface 12 and the second main surface 13 of the light guide 10 and sufficiently mixed. The light beams of the first color (R), the second color (G), and the third color (B) emitted from the first to third laser elements LD1, LD2, and LD3, respectively, are uniformly mixed inside the light guide 10 to have a desired color (for example, white), and made incident on the prism sheet PS and the diffusion film ST.

As shown in FIG. 4, the light made incident on the side surface 11 of the light guide 10 through the collimating lenses 20 has the parallel property in the second direction Y. For this reason, the light uniformly propagates to a distant place in the first direction X. The non-uniformity in luminance on the first main surface (emission surface) 12 of the light guide 10 is suppressed from one end 10A close to the light sources LS to the other end 10B on the opposite side.

In addition, since the light made incident through the collimating lenses 20 has the parallel property in the second direction Y, the light is not mixed in the second direction Y. The light beams from the light sources LS1, LS2, LS3, LS4, and LS5 arranged along the second direction Y propagate independently of each other, inside the light guide 10. For example, if each of the light sources LS1, LS2, LS3, LS4, and LS5 is turned on or off individually, a part of the first main surface 12 of the corresponding light guide 10 is turned on or off individually. The brightness of the light sources LS can be controlled by the above-explained control module CM.

Parts of the first main surface 12 corresponding to the light sources LS1 and LS2 are called sub-areas A1 and A2. Parts of the first main surface 12 corresponding to the light source LS3, LS4, and LS5 are called sub-areas A3, A4, and A5, though not illustrated in the drawing. The sub-areas A1, A2, A3, A4, and A5 can be set in a strip shape elongated in the first direction X. In the present embodiment, the brightness of the sub-areas A1, A2, A3, A4, and A5 of the light guide 10 can be adjusted individually by controlling the light sources LS1, LS2, LS3, LS4, and LS5 individually.

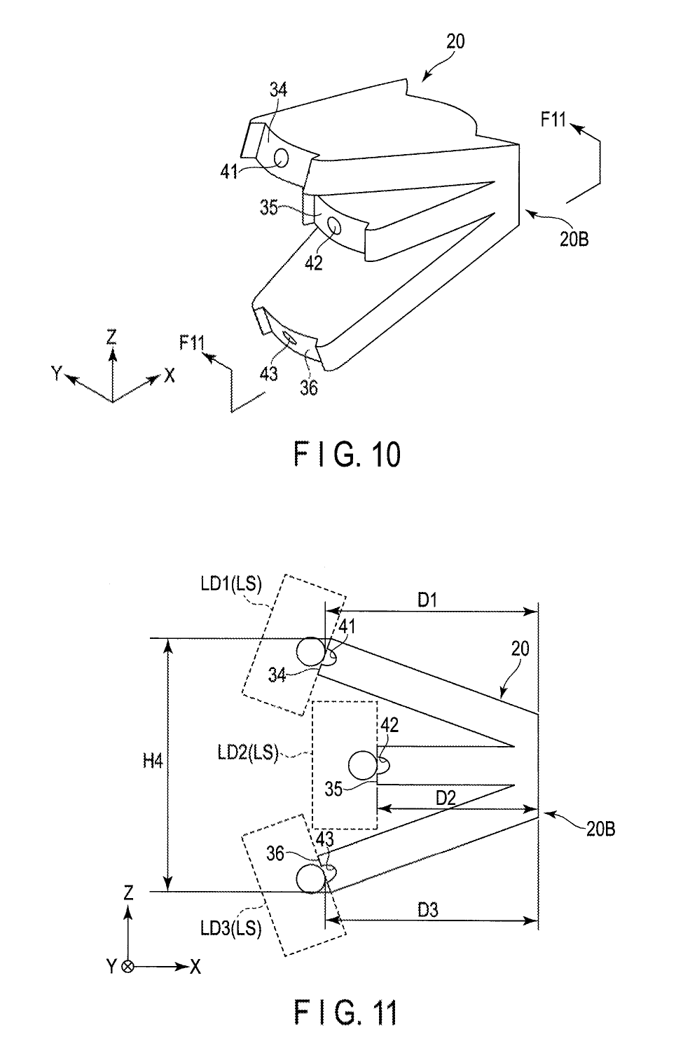

FIG. 10 is a perspective view showing the other example of the collimating lens according to the present embodiment. The distances from the distal end 20B to the fourth to sixth surfaces 34, 35, and 36 are made approximately equal to each other and the fourth to sixth surfaces 34, 35, and 36 are formed continuously, in the example shown in FIG. 6, but the fourth to sixth surfaces 34, 35, and 36 are formed to be discontinuously broken off in the other example shown in FIG. 10.

FIG. 11 is a cross-sectional view seen along line F11-F11 in FIG. 10. In the example shown in FIG. 11, the distance D2 from the distal end 20B to the second recess portion 42 of the fifth surface 35 is shorter than the distance D1 from the distal end 20B to the first recess portion 41 of the fourth surface 34 and shorter than the distance D3 from the distal end 20B to the third recess portion 43 of the sixth surface 36. The distance D2 may be longer than the distance D1 and the distance D3. The distance D2 may be longer than the distance D1 and shorter than the distance D3. The distance D2 may be shorter than the distance D1 and longer than the distance D3. In short, any one of the distance D1, D2, and D3 may be shorter than the other distances.

In the example shown in FIG. 11, the fifth surface 35 is located forward and backward from the fourth surface 34 and the sixth surface 36 in the first direction X. For this reason, the second laser element LD2 opposed to the fifth surface 35 can be displaced forward and backward from the first laser element LD1 opposed to the fourth surface 34 and the third laser element LD3 opposed to the sixth surface 36. Since the first to third laser elements LD1, LD2, and LD3 do not need to be overlapped in the third direction Z, the thickness H4 of the collimating lens 20 in the third direction Z can be made small and the illumination device BL can be miniaturized.

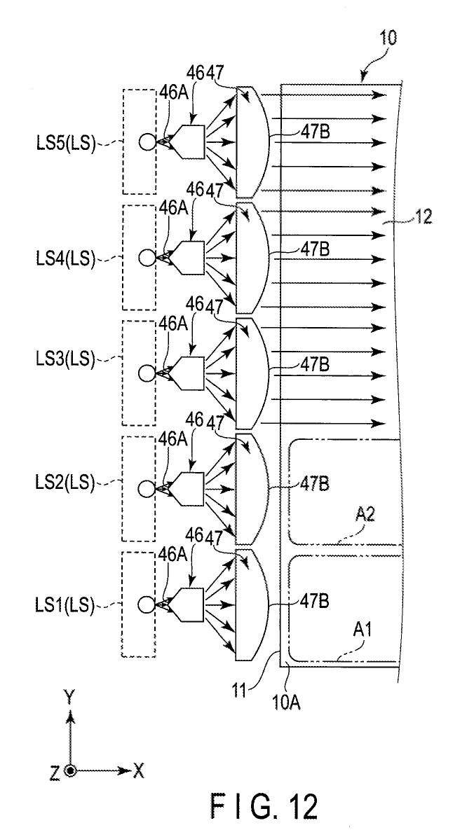

FIG. 12 is a plan view showing the other example of the present embodiment. The light guide 10 comprises the collimating lenses 20 in the example shown in FIG. 4, but the light guide 10 comprises Powell lenses (line generators) 46 and cylindrical lenses 47 instead of the collimating lenses 20 in the other example shown in FIG. 12. The combination of the Powell lenses 46 and the cylindrical lenses 47 is an example of the lens (optical director) converting the light emitted from the light source LS into light having the parallel property in the second direction Y and the diffusibility in the third direction Z.

Each of the Powell lenses 46 has an incidence surface 46A formed in the round roof shape, decreases the intensity at a central portion while increasing the intensity at both end portions of the emitted light, and converts spotlight from the light source LS into linear light having a uniform intensity in the second direction Y. The light emitted from the Powell lenses 46 is made incident on the cylindrical lens 47.

The cylindrical lens 47 has an emission surface 47B of a shape (cylindrical surface) formed by partially cutting down a cylinder having a central axis in the third direction Z, and controls the width of the light in the second direction Y. The light emitted from the cylindrical lens 47 is converted into, for example, light having the parallel property in the second direction. The cylindrical lens 47 may be disposed such that its columnar surface faces the incidence side. A Fresnel lens having a lens surface obtained by dividing the columnar surface of the cylindrical lens 47 may be used instead of the cylindrical lens 47. Alternately, a graded index (GRIN) lens which linearly condenses parallel light by using not the curvature of the lens contour but the refractive index distribution inside the lens or the like may be used.

The combination of the Powell lenses 46 and the cylindrical lenses 47 converts the light emitted from the light source LS into the light having the parallel property in the second direction Y and having the diffusibility in the third direction Z, similarly to the collimating lenses 20. Furthermore, the intensity of the light in the second direction Y is uniformly converted by the Powell lenses 46. As a result, non-uniformity in light in the second direction Y can be further suppressed about planar light emitted from the illumination device BL.

In the illumination device BL of the present embodiment configured as explained above, as shown in FIG. 2, the second direction Y (shorter side direction of the light guide 10) in which a plurality of light sources LS are arranged intersects the third direction Z (thickness direction of the light guide 10) in which the first to third laser elements LD1, LD2, and LD3 emitting the light of the first to third colors (R, G, and B) are arranged. Thus, even if the light parallel to the second direction Y applied from the light source LS, the light of the first to third colors (R, G, and B) can be mixed uniformly.

More specifically, the light sources LS arranged in the second direction Y emit the light in the first direction X (longitudinal direction of the light guide 10) intersecting the second direction Y. The colors of the light traveling inside the light guide 10 in the first direction X can hardly be mixed in the direction of arrangement of the light sources LS (second direction Y), but the light is reflected on the first main surface 12 and the second main surface 13, and the colors of the light are uniformly mixed in the thickness direction (third direction Z) of the light guide 10 and the direction (first direction X) of travel of the light.

In each of the light sources LS1, LS2, LS3, LS4, and LS5, the first to third laser elements LD1, LD2, and LD3 emitting the light of the first to third colors (R, G, and B) are arranged in not the second direction Y but the third direction Z. Since the direction of arrangement of the light sources LS (second direction Y) intersects the direction of arrangement of the first to third laser elements LD1, LD2, and LD3 (third direction Z), the first to third colors (R, G, and B) of the light emitted from the first to third laser elements LD1, LD2, and LD3 can be mixed uniformly, according to the present embodiment.

The illumination device BL of the present embodiment comprises the collimating lenses 20 converting the light emitted from the light sources LS into the light having the parallel property in the second direction Y and the diffusibility in the third direction Z. Since the light made incident on the light guide 10 has the parallel property in the second direction Y, the light can be uniformly propagated from the end 10A of the light guide 10 close to the light sources LS in the first direction X (longer side direction of the light guide 10) to the other end 10B on the side opposite to the light sources LS. In addition, since the light has the diffusibility in the third direction Z, the light can be reflected on the first main surface 12 and the second main surface 13 of the light guide 10 and the first to third colors of the light can be mixed uniformly.

The distal end 20B of each of the collimating lenses 20 faces the side surface 11 of the light guide 10, and is formed to have the thickness approximately equal to the thickness of the side surface 11. The proximal end 20A opposed to the first laser elements LD1, LD2, and LD3 is formed to be larger in the third direction Z. For this reason, the first to third laser elements LD1, LD2, and LD3 larger than the thickness of the light guide 10 can be approximately selected irrespective of the thickness of the light guide 10.

In addition, the distal end 20B (emission side) of each of the collimating lenses 20 is formed to be larger than the proximal end 20A (incidence side) in the second direction Y. Since the light from the incidence side can be extended on the emission side in the second direction Y, the number of the light sources LS can be reduced and the power consumption of the illumination device BL can be suppressed. Furthermore, the distance between the light sources LS and the light guide 10 in the first direction X can be reduced and the illumination device BL can be miniaturized.

Each of the collimating lenses 20 has the first recess portions 41, 42, and 43 on which the light emitted from the first to third laser elements LD1, LD2, and LD3 are made incident, as shown in FIG. 5 and FIG. 6. Since the first to third recess portions 41, 42, and 43 can extend the light from the first to third laser elements LD1, LD2, and LD3, in the second direction Y and the third direction Z, the number of the light sources LS can be reduced and the power consumption of the illumination device BL can be suppressed. Furthermore, the distance between the light sources LS and the light guide 10 in the first direction X can be reduced and the illumination device BL can be miniaturized.

As the other example of the present embodiment, if the collimating lens 20 is configured such that the distances D1, D2, and D3 from the distal end 20B to the fourth surface 34, the fifth surface 35, and the sixth surface 36 of the collimating lens 20 are different from each other as shown in FIG. 10, the thickness H4 of the collimating lens 20 in the third direction Z can be made smaller since the first to third laser elements LD1, LD2, and LD3 can be displaced forward and backward in the first direction X as shown in FIG. 11.

Alternatively, as the other example of the present embodiment, if the illumination device BL is configured to comprise the Powell lenses 46 and the cylindrical lenses 47 instead of the collimating lenses 20 as shown in FIG. 12, the spot light from the light sources LS can be converted into the linear light having the uniform intensity in the second direction Y by the Powell lens 46, and the non-uniformity in luminance in the second direction Y can be thereby further suppressed in the planar light emitted from the illumination device EL.

In addition, various desirable effects can be obtained from the present embodiment.

### Second Embodiment

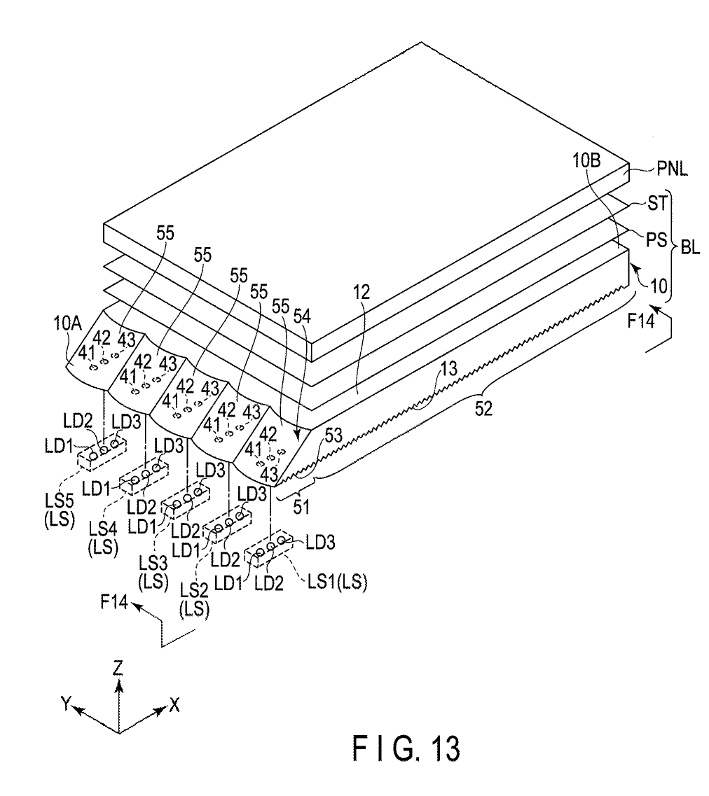

The first embodiment discloses the configuration of the illumination device BL in which the first to third laser elements LD1, LD2, and LD3 are arranged in the third direction Z. In the second embodiment, a configuration of the illumination device BL in which the first to third laser elements LD1, LD2, and LD3 are arranged in the first direction X will be explained with reference to FIG. 13 to FIG. 15. FIG. 13 is a perspective view showing a schematic structure of an illumination device BL according to the second embodiment. As shown in FIG. 13, a light guide 10 according to the second embodiment includes an edge portion 51 located at one end 10A of the first direction X, and a light emitting portion 52 which occupies most part of the light guide 10 including the other end 10B.

The edge portion 51 includes an incidence surface 53 provided on a second main surface 13, and a reflection surface 54 provided between a first main surface 12 and the second main surface 13. A reflective surface 54, for example, makes an obtuse angle with the first main surface 12, makes an acute angle with the second main surface 13, and is opposed to the incidence surface 53.

The reflective surface 54 includes a plurality of concave mirrors 55 provided to correspond to the respective light sources LS. The concave mirror 55 is an example of an optical director converting the light emitted from the light source LS into light having a parallel property in the second direction Y and having a diffusibility in the third direction Z. Each of the concave mirrors 55 has a concave surface (reverse cylinder surface) opposed to the incidence surface 53, inside the light guide 10, and reflects the light incident on the incidence surface 53 towards the light emitting portion 52 while controlling a width of the like in the second direction Y. The light reflected on the concave mirror 55 has the parallel property in the second direction Y and has the diffusibility in the third direction Z.

As shown in FIG. 13, a plurality of light sources LS (LS1, LS2, LS3, LS4, and LS5) are arranged in the second direction Y, on the incidence surface 53.

In each of the light sources LS, the first to third laser elements LD1, LD2, and LD3 are arranged in the first direction X. In the light source LS1, the first to third laser elements LD1, LD2, and LD3 are arranged in the first direction X. Similarly, the first to third laser elements LD1, LD2, and LD3 are arranged in the first direction X, in each of the light sources LS2, LS3, LS4, and LS5.

In such a position, each of the laser elements LD is fixed in a direction in which the half width is large in the direction (second direction Y) of arrangement of the light sources LS and the half width becomes narrow in the direction (first direction X) of arrangement of the laser elements LD.

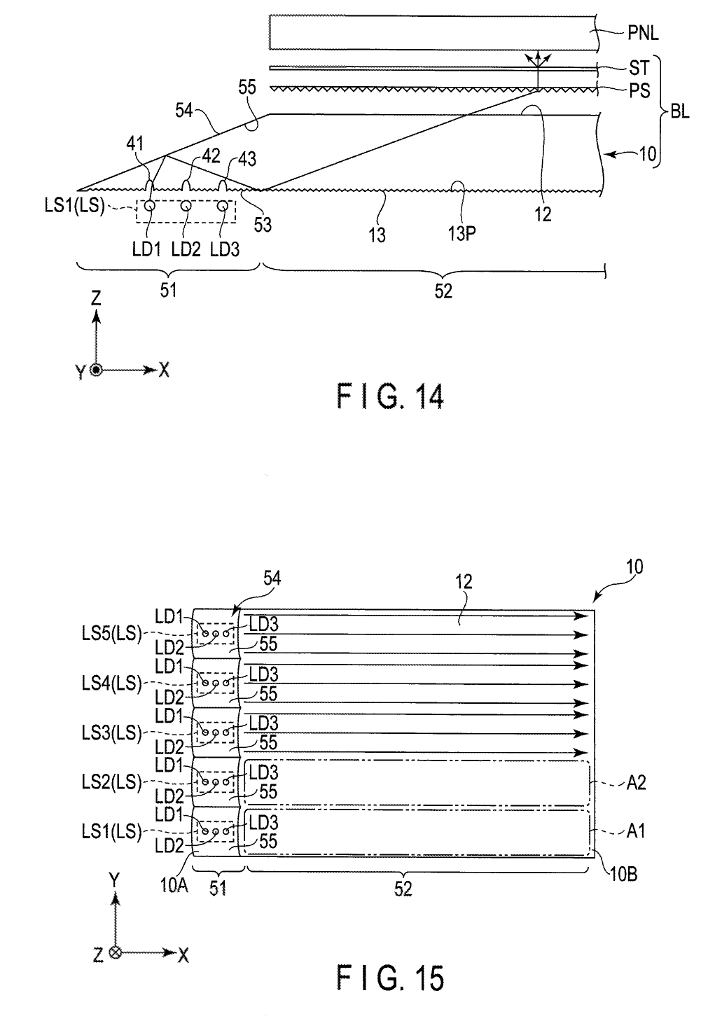

FIG. 14 is a cross-sectional view seen along line F14-F14 in FIG. 13. As shown in FIG. 14, the first to third recess portions 41, 42, and 43 are formed on the incidence surface 53. The first to third recess portions 41, 42, and 43 are examples of the optical diffusion structure. If the light emitted from the light source LS is made incident on the first to third recess portions 41, 42, and 43, the width of the light is expanded in the first direction X and the second direction Y.

Since the optical diffusion structure aims to extend the optical path, the surface shape is not limited to the concave shape but may be a convex shape. The radiation intensity of the light is desirably high in the thickness direction (first direction X) of the light path immediately after the light has been passed through the optical diffusion structure. In this case, the light passed through the optical diffusion structure is reflected on the concave mirror 55 and propagated to the light emitting portion 52 as the light having the radiation intensity in the third direction Z. If the radiation intensity of the light is high in the first direction X immediately after the light has been passed through the optical diffusion structure, the radiation intensity of the light propagated to the light emitting portion 52 after reflection becomes high in the third direction Z.

FIG. 15 is a plan view of the illumination device BL according to the second embodiment. As shown in FIG. 15, the first main surface 12 includes sub-areas A1 and A2 corresponding to the light sources LS1 and LS2, in the light emitting portion 52. The first main surface 12 also includes areas A3, A4, and A5 corresponding to the light sources LS3, LS4, and LS5, though not illustrated in the drawing. In the second embodiment, too, the brightness of the sub-areas A1 to A5 can be adjusted individually, similarly to the first embodiment.

In the second embodiment, as shown in FIG. 13, the direction (second direction Y) of arrangement of the light sources LS intersects the direction (first direction X) of arrangement of the first to third laser elements LD1, LD2, and LD3 emitting the light of the first to third colors (R, G, and B).

As explained above, the colors of the light emitted from the light sources LS arranged in the second direction Y can hardly be mixed in the direction of arrangement of the light sources LS (second direction Y), but are uniformly mixed in the thickness direction (third direction Z) of the light guide 10 and the direction (first direction X) of travel of the light. In second embodiment, since the first to third laser elements LD1, LD2, and LD3 are arranged in the first direction X, the first to third colors (R, G, and B) of the light can be mixed uniformly even if the light parallel to the second direction Y is applied from the light sources LS, similarly to the first embodiment.

The illumination device BL of the second embodiment comprises the concave mirror 55 provided on the reflection surface 54 to reflect the incident light toward the light emitting portion 52. Since the light reflected on the concave mirror 55 has the parallel property in the second direction Y, the light can be uniformly propagated to the other end 10B through the light emitting portion 52. Since the light reflected on the concave mirror 55 has the diffusibility in the third direction Z, the light can be reflected on the first main surface 12 and the second main surface 13 of the light guide 10 and the first to third colors (R, G, and B) of the light can be mixed uniformly.

### Third Embodiment

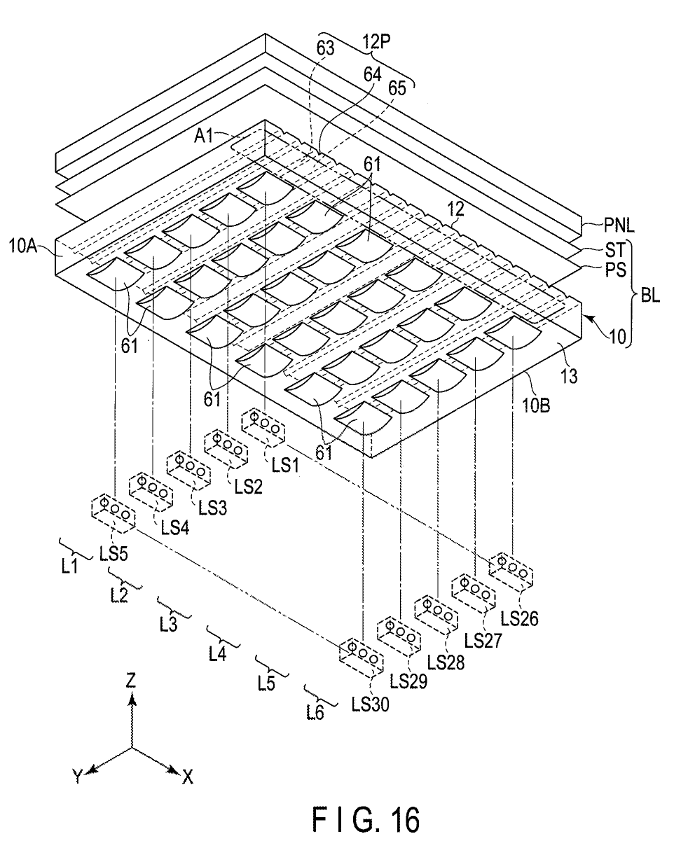

A third embodiment will be described with reference to FIG. 16 to FIG. 18. In the third embodiment, a plurality of light sources LS are arrayed in a planar shape, directly under the light guide 10. In each of the light sources LS, first to third laser elements LD1, LD2, and LD3 are arranged in the first direction X.

FIG. 16 is a perspective view showing a schematic structure of an illumination device BL according to the third embodiment. As shown in FIG. 16, the illumination device BL of the third embodiment comprises a plurality of light sources LS that apply light to a second main surface 13 the light guide 10. The second main surface 13 is an example of an incidence surface in the third embodiment. The light sources LS include light sources LS1 to LS5 arranged in the second direction Y. The light sources LS1 to LS5 may be hereinafter called a first line L1.

The third embodiment further includes, as the light sources LS, a second line L2 (light sources LS6 to LS10 not illustrated), a third line L3 (light sources LS11 to LS15 not illustrated), a fourth line L4 (light sources LS16 to LS20 not illustrated), a fifth line L5 (light sources LS21 to LS25 not illustrated), and a sixth line L6 (light sources LS 26 to LS30). The light sources LS6 to LS30 of the second to sixth lines L2 to L6 have approximately the same shapes and functions as the light sources LS1 to LS5 of the first line L1. For this reason, the light sources LS1 to LS5 will be explained in detail as representative light sources and the overlapping explanations of the light sources LS6 to LS30 may be omitted.

Similarly to the light sources LS1 to LS5 of the first line L1, the light sources LS6 to LS10 of the second line L2, the light sources LS11 to LS15 of the third line L3, the light sources LS16 to LS20 of the fourth line L4, the light sources LS21 to LS25 of the fifth line L5, and the light sources LS26 to LS30 of the sixth line L6 are arranged in the second direction Y.

The first to third laser elements LD1, LD2, and LD3 are arranged in the first direction X, in each of the light sources LS1, LS2, LS3, LS4, and LS5. Similarly, the first to third laser elements LD1, LD2, and LD3 are arranged in the first direction X, in each of the light sources LS6 to LS30.

In such a position, each of the laser elements LD is fixed in a direction in which the half width is large in the direction (second direction Y) of arrangement of the light sources LS and the half width becomes narrow in the direction (first direction X) of arrangement of the laser elements LD.

Each of the light sources LS1 to LS30 are opposed to a plurality of cylindrical lenses 61 provided on the second main surface 13. The cylindrical lens 61 is an example of an optical diffusion structure. Each cylindrical lens 61 has a cylindrical surface of the central axis in the first direction X, and controls the width of the light in the second direction Y. A Fresnel lens having a lens surface obtained by dividing the cylindrical surface of the cylindrical lens 61 may be provided on the second main surface 13 instead of the cylindrical lens 61.

The cylindrical lenses 61 opposed to the light sources LS1 to LS5 of the first line L1 are arranged in the second direction Y. Similarly, the cylindrical lenses 61 opposed to the second line L2, the third line L3, the fourth line L4, the fifth line L5, and the sixth line L6 are arranged in the second direction Y.

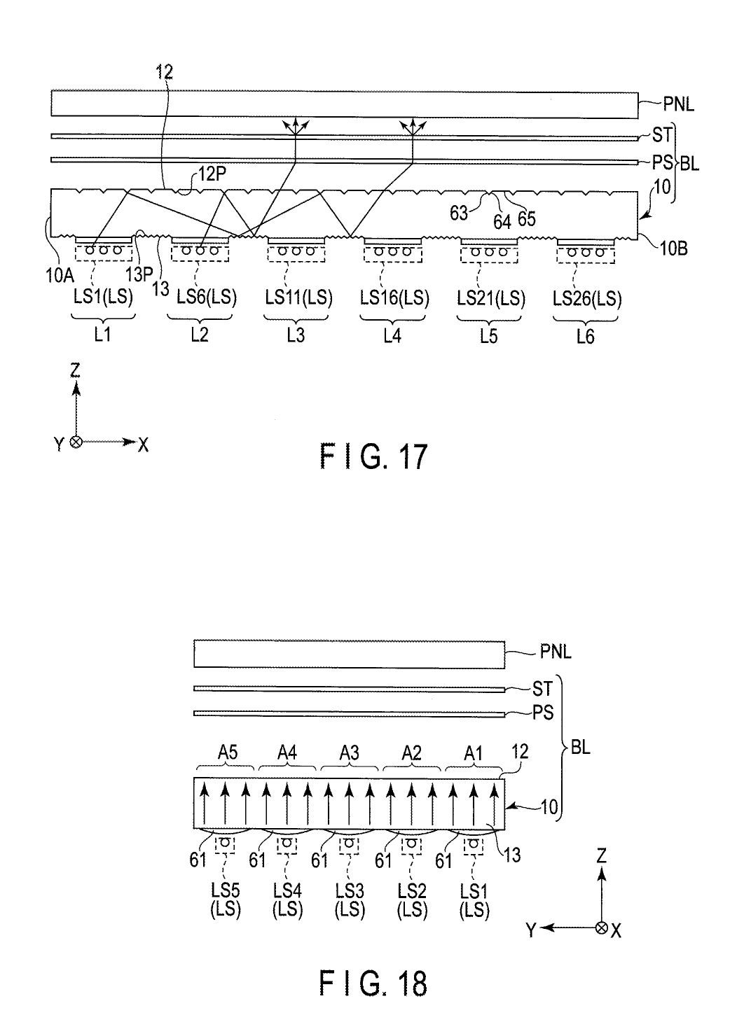

FIG. 17 is a right side view of the illumination device BL according to the third embodiment seen from the second direction Y. As shown in FIG. 17, a prism pattern 13P which reflects the light incident on the light guide 10 is formed at a portion at which the cylindrical lens 61 is not provided, on the second main surface 13. The portion at which the cylindrical lens 61 is not provided is located, for example, between the end 10A of the light guide 10 and the first line L1 or between the first line L1 and the second line L2.

In the third embodiment, as shown in FIG. 17, a prism pattern 12P which diffuses the light incident on the cylindrical lens 61 in the first direction X is formed on the first main surface 12. The prism pattern 12P includes a plurality of prisms. Each of the prisms has, for example, first and the second inclined planes 63 and 64 that are inclined from an XY plane, and a flat surface 65 parallel to the XY plane. The first inclined plane 63 faces the end 10A of the light guide 10 while the second inclined plane 64 faces the other end 10B of the light guide 10. A ridge where the adjacent first and second inclined planes 63 and 64 intersect extends, for example, in the second direction Y. The combination of the prism pattern 12P (prisms) and the cylindrical lenses 61 is an example of the optical director which converts the light emitted from the light sources LS into light having the parallel property in the second direction Y and the diffusibility in the third direction Z.

As shown in FIG. 17, the light beams emitted from the light source LS1 of the first line L1, the light source LS6 of the second line L2, the light source LS11 of the third line L3, the light source LS16 of the fourth line L4, the light source LS21 of the fifth line L5, and the light source LS26 of the sixth line L6 are passed through the cylindrical lenses 61, reflected on the main surfaces 12 and 13, diffused by the prism pattern 12P of the first main surface 12 in the first direction X, and then mixed with each other. The light beams of the light sources LS1, LS6, LS11, LS16, LS21, and LS26 mixed inside the light guide 10 are emitted from the corresponding sub-area A1 (shown in FIG. 16).

FIG. 18 is a front view of the illumination device BL according to the third embodiment seen from the first direction X. As shown in FIG. 18, the light source LS1 (and light sources LS6, LS11, LS16, LS21, and LS26 not illustrated) corresponds to the sub-area A1. Similarly, the light source LS2 (and light sources LS7, LS12, LS17, LS22, and LS27 not illustrated) corresponds to the sub-area A2, the light source LS3 (and the light sources LS8, LS13, LS18, LS23, and LS28 not illustrated) corresponds to the sub-area A3, the light source LS4 (and the light sources LS9, S14, LS19, LS24, and LS29 not illustrated) corresponds to the sub-area A4, and the light source LS5 (light sources LS10, LS15, LS20, LS25, and LS30 not illustrated) corresponds to the sub-area A5. For this reason, in third embodiment, too, the brightness of the sub-areas A1 to A5 can be adjusted individually, similarly to the first and second embodiments.

In the third embodiment, the direction (second direction Y) of arrangement of the light sources LS1 to LS5 of the first line L1 intersects the direction (first direction X) of arrangement of the first to third laser elements LD1, LD2, and LD3, similarly to the second embodiment. Similarly to the first line L1, the direction (second direction Y) of arrangement of the light sources LS6 to LS10 of the second line L2, the direction (second direction Y) of arrangement of the light sources LS11 to LS15 of the third line L3, the direction (second direction Y) of arrangement of the light sources LS16 to LS20 of the fourth line L4, the direction (second direction Y) of arrangement of the light sources LS21 to LS25 of the fifth line L5, and the direction (second direction Y) of arrangement of the light sources L26 to LS30 of the sixth line L6 intersect the direction (first direction X) of arrangement of the first to third laser elements LD1, LD2, and LD3. The first to third colors (R, G, and B) of the light can be thereby mixed uniformly.

The third embodiment comprises a plurality of cylindrical lenses 61 and a plurality of prism patterns 12P instead of the concave mirror 55 of the second embodiment. The light emitted from the light sources LS can be converted into the light having the parallel property in the second direction Y and having the diffusibility in the first direction X by the combination of the cylindrical lenses 61 and the prism patterns 12P.

It should be noted that change of design may be arbitrarily added to the present invention, based on the display device described as one of the embodiments. The accompanying claims and their equivalents are intended to cover display devices modified as would fall within the scope and spirit of the inventions.

For example, the prism patterns 12P of the third embodiment may be provided on the first main surface (emission surface) 12 of the first and second embodiments. The Powell lenses 26 of the first embodiment may be disposed between the light sources LS and the cylindrical lenses 61 in the third embodiment.

What is claimed is:

1. An illumination device, comprising:
a light guide extending in a first direction and a second direction intersecting the first direction and having a thickness in a third direction intersecting the first and second directions;
a plurality of light sources including a first laser element emitting light of a first color and a second laser element emitting light of a second color different from the first color, and applying light to the light guide; and
a plurality of light diffusion structures provided to correspond to the respective light sources, and located on an incidence surface of the light guide on which light from the light sources is made incident or between the incidence surface and the light sources,
wherein
the light sources are arranged in the second direction, and
the first laser element and the second laser element are arranged in the first direction or the third direction, in each of the light sources.

2. The illumination device of claim 1, further comprising:
a lens converting the light emitted from the light sources into light having a parallel property in the second direction and a diffusibility in the third direction.

3. The illumination device of claim 1, further comprising:
a collimating lens controlling a width of the light in the second direction.

4. The illumination device of claim 1, further comprising:
a Powell lens expanding light in the second direction; and
a cylindrical lens controlling the width of the light passed through the Powell lens in the second direction.

5. The illumination device of claim 1, wherein
each of the light diffusion structures is a concave or convex structure.

6. The illumination device of claim 1, wherein
the light guide includes an emission surface from which the light incident on the incidence surface is emitted,
the emission surface includes a plurality of sub-areas extending in the first direction and corresponding to the respective light sources, and
luminance of the light sources is controlled for each of the sub-areas.

7. The illumination device of claim 2, further comprising:
a collimating lens controlling a width of the light in the second direction.

8. The illumination device of claim 2, further comprising:
a Powell lens expanding light in the second direction; and
a cylindrical lens controlling the width of the light passed through the Powell lens in the second direction.

9. The illumination device of claim 2, wherein
each of the light diffusion structures is a concave or convex structure.

10. The illumination device of claim 2, wherein
the light guide includes an emission surface from which the light incident on the incidence surface is emitted,
the emission surface includes a plurality of sub-areas extending in the first direction and corresponding to the respective light sources, and
luminance of the light sources is controlled for each of the sub-areas.

11. The illumination device of claim 3, wherein
the collimating lens includes an incidence side opposed to the first laser element and the second laser element, and an emission side opposed to the incidence side, and
the emission side is larger than the incidence side in the second direction and smaller than the incidence side in the third direction.

12. The illumination device of claim 3, wherein
each of the light diffusion structures is a concave or convex structure.

13. The illumination device of claim 3, wherein
the light guide includes an emission surface from which the light incident on the incidence surface is emitted,
the emission surface includes a plurality of sub-areas extending in the first direction and corresponding to the respective light sources, and
luminance of the light sources is controlled for each of the sub-areas.

14. The illumination device of claim 4, wherein
each of the light diffusion structures is a concave or convex structure.

15. The illumination device of claim 4, wherein
the light guide includes an emission surface from which the light incident on the incidence surface is emitted,
the emission surface includes a plurality of sub-areas extending in the first direction and corresponding to the respective light sources, and
luminance of the light sources is controlled for each of the sub-areas.

16. The illumination device of claim 11, wherein
the light diffusion structures are provided on the collimating lens.

17. The illumination device of claim 11, wherein
each of the light diffusion structures is a concave or convex structure.

18. The illumination device of claim 11, wherein
the light guide includes an emission surface from which the light incident on the incidence surface is emitted,
the emission surface includes a plurality of sub-areas extending in the first direction and corresponding to the respective light sources, and
luminance of the light sources is controlled for each of the sub-areas.

19. The illumination device of claim 16, wherein
each of the light diffusion structures is a concave or convex structure.

20. The illumination device of claim 16, wherein
the light guide includes an emission surface from which the light incident on the incidence surface is emitted,
the emission surface extends in the first direction and includes a plurality of sub-areas corresponding to the respective light sources, and
luminance of the light sources is controlled for each of the sub-areas.
